(19) United States
(12) Patent Application Publication
(10) Pub. No.: US 2022/0374607 A1
(43) Pub. Date: Nov. 24, 2022

(54) INFERENTIAL KNOWLEDGE CONSTRUCTION SUPPORT APPARATUS, INFERENTIAL KNOWLEDGE CONSTRUCTION SUPPORT METHOD, AND COMPUTER-READABLE RECORDING MEDIUM

(71) Applicant: NEC Corporation, Minato-ku, Tokyo (JP)

(72) Inventors: Takuya KAWADA, Tokyo (JP); Itaru HOSOMI, Tokyo (JP)

(73) Assignee: NEC Corporation, Minato-ku, Tokyo (JP)

(21) Appl. No.: 17/761,278

(22) PCT Filed: Oct. 2, 2019
(86) PCT No.: PCT/JP2019/038903

§ 371 Date: Mar. 17, 2022

(51) Int. Cl. G06F 40/30; G06F 3/0484; G06F 3/0482; G06F 40/166; G06F 40/247; G06F 40/242

(52) U.S. Cl. CPC G06F 40/30; G06F 3/0484; G06F 3/0482; G06F 40/166; G06F 40/247; G06F 40/242

(57) ABSTRACT

An inferential knowledge construction support apparatus 1 has a literal generation unit 2 that generates literal information based on the extracted elements, a rule generation unit 3 that estimates a causal or implicational relation between literals, using plural pieces of literal information, and generates rule information by allocating literal information estimated to be in the causal/implicational relation to an antecedent and a consequent, a display information generation unit 4 that generates display information to be used for causing a display device to output a rule editing user interface for displaying, in a juxtaposed manner, a literal display area for displaying the literal information and descriptive information corresponding to the literal information and a rule display area for displaying the rule information and descriptive information corresponding to the rule information, and an editing unit 5 that enables an operator to edit the rule information, using the rule editing user interface.

### TECHNICAL FIELD

The invention relates to an inferential knowledge construction support apparatus and an inferential knowledge construction support method for supporting construction of inferential knowledge, and further relates to a computer-readable recording medium that includes a program recorded thereon for realizing the apparatus and method.

### BACKGROUND ART

In recent years, in fields such as AI (Artificial Intelligence), there have been calls for a method that is able to ensure explainability that decision makers will find compelling, in relation to resolving advanced and complex social issues such as those with only fragmentary information and that, furthermore, require human judgment in decision making, including cybersecurity, management decisions and plant control.

A method for presenting a reasonable hypothesis (consequence) from a given fact by automating inference including hypothesis (deductive) inference has been proposed as a method that is able to ensure explainability. Furthermore, a method of ensuring explainability by clarifying the path from fact to hypothesis (consequence) has been proposed.

Inference is an operation for creating new knowledge from inferential knowledge (knowledge base having rule information indicating rules and observation information indicating observed facts). Thus, inferential knowledge needs to be prepared in advance. Accordingly, the establishment of a method for efficiently constructing accurate and sufficient inferential knowledge is desired.

Inferential knowledge is a set having a rule and an observation required in inference. A rule is information indicating a causal/implicational relation between certain events. Also, a rule has an antecedent indicating a premise (cause) and a consequent indicating a consequence (result). An observation is information certified as fact. Rules and observations have one or more literals. Furthermore, a literal has one predicate symbol and one or more arguments.

As a related technology, Patent Document 1 discloses a technology for automatically constructing inferential knowledge from natural language sentences written in natural language. According to this technology, first, knowledge descriptions in natural language undergo natural language analysis with reference to an analysis dictionary. Then, syntactic information is decided, with reference to a target domain semantic model and deep case decision rules, using the analysis results of the natural language analysis. Then, intermediate results generated by adding syntactic information to the analysis results are converted to a knowledge description format of inferential knowledge, with reference to the target domain semantic model. Thereafter, inferential knowledge is automatically constructed by storing conversion results in inferential knowledge.

### LIST OF RELATED ART DOCUMENTS

### Patent Document

Patent Document 1: Japanese Patent Laid-Open Publication No. 06-195383

### SUMMARY OF INVENTION

### Technical Problems

However, even using the technology of Patent Document 1 described above, rules that contain erroneous literals may be generated, since it is not always possible to performed accurate and sufficient natural language analysis on knowledge description in natural language. In such cases, an operator must manually correct the erroneous literals.

Accordingly, the operator who corrects erroneous literals needs specialized knowledge relating to the domain to be built, knowledge of natural language processing (predicate-argument structure), knowledge relating to the specifications of literals, and other such knowledge.

An example object of the invention is to provide an inferential knowledge construction support apparatus, an inferential knowledge construction method and a computer-readable recording medium that provide support to an operator in order to efficiently construct inferential knowledge.

### Solution to the Problems

In order to achieve the above example object, an inferential knowledge construction support apparatus in one aspect of the invention includes:

a literal generation means for extracting elements corresponding to a predicate symbol and an argument from descriptive information indicating a sentence, and generating literal information based on the extracted elements;

a rule generation means for estimating a causal/implicational relation between literals, using plural pieces of the literal information, and generating rule information by allocating literal information estimated to be in the causal/implicational relation to an antecedent and a consequent;

a display information generation means for generating display information to be used for causing a display device to output a rule editing user interface for displaying, in a juxtaposed manner, a literal display area for displaying the literal information and descriptive information corresponding to the literal information and a rule display area for displaying the rule information and descriptive information corresponding to the rule information; and

an editing means for enabling an operator to edit the rule information, using the rule editing user interface.

Also, in order to achieve the above example object, an inferential knowledge construction support method in one aspect of the invention includes:

(a) extracting elements corresponding to a predicate symbol and an argument from descriptive information indicating a sentence, and generating literal information based on the extracted elements;

(b) estimating a causal/implicational relation between literals, using plural pieces of the literal information, and generating rule information by allocating literal information estimated to be in the causal/implicational relation to an antecedent and a consequent;

(c) generating display information to be used for causing a display device to output a rule editing user interface for displaying, in a juxtaposed manner, a literal display area for displaying the literal information and descriptive information corresponding to the literal information and a rule display area for displaying the rule information and descriptive information corresponding to the rule information; and

(d) enabling an operator to edit the rule information, using the rule editing user interface.

Furthermore, in order to achieve the above example object, a computer-readable recording medium has a program recorded thereon, the program including instructions that cause a computer to carry out:

(a) a step of extracting elements corresponding to a predicate symbol and an argument from descriptive information indicating a sentence, and generating literal information based on the extracted elements;

(b) a step of estimating a causal/implicational relation between literals, using plural pieces of the literal information, and generating rule information by allocating literal information estimated to be in the causal/implicational relation to an antecedent and a consequent;

(c) a step of generating display information to be used for causing a display device to output a rule editing user interface for displaying, in a juxtaposed manner, a literal display area for displaying the literal information and descriptive information corresponding to the literal information and a rule display area for displaying the rule information and descriptive information corresponding to the rule information; and

(d) a step of enabling an operator to edit the rule information, using the rule editing user interface.

### Advantageous Effects of the Invention

According to the invention as described above, support can be provided to an operator in order to efficiently construct inferential knowledge.

### BRIEF DESCRIPTION OF THE DRAWINGS

FIG. 1 is a diagram for describing an example of a predicate list.

FIG. 2 is a diagram for describing an example of an inferential knowledge construction support apparatus.

FIG. 3 is a diagram for describing an example of a user interface.

FIG. 4 is a diagram showing an example of a system having the knowledge construction support apparatus.

FIG. 5 is a diagram for describing an example of a natural sentence.

FIG. 6 is a diagram for describing an example of a natural sentence.

FIG. 7 is a diagram for describing an example in which a natural sentence display area, a literal display area and a rule display area are displayed.

FIG. 8 is a diagram for describing an example in which a natural sentence display area, a literal display area and an observation display area are displayed.

FIG. 9 is a diagram for describing an example of editing for adding a literal to a rule.

FIG. 10 is a diagram for describing an example of editing for adding a new literal to a rule.

FIG. 11 is a diagram for describing an example of editing for adding a new literal to a rule.

FIG. 12 is a diagram for describing an example of editing for adding a new literal to a rule.

FIG. 13 is a diagram for illustrating an example of editing for adding a new literal to the rule.

FIG. 14 is a diagram for describing an example of editing for deleting a literal from a rule.

FIG. 15 is a diagram for describing an example of editing a logical structure of a rule.

FIG. 16 is a diagram for describing an example of operations of the inferential knowledge construction support apparatus.

FIG. 17 is a diagram showing an example of a computer for realizing the inferential knowledge construction support apparatus.

### EXAMPLE EMBODIMENTS

First, inference and inferential knowledge will be described.

Known inference mainly includes “deductive inference”, “inductive inference” and “hypothetical inference” (abductive inference: abduction). Of these, deductive inference and hypothetical inference are both inference that involves creating new knowledge from observed facts (observations) and rules.

Deductive inference is an inference method that involves deriving a conclusion B from the major premise (rule) that “B holds if A” and the minor premise (observation) that A holds. Hypothetical inference is an inference method that involves surmising that A holds from the rule that “B holds if A” and the observation that B holds. In the example embodiment, basically deductive inference or hypothetical inference is assumed.

Inferential knowledge is a set of a rule and an observation. A rule is a set of logical formulas in which the relation (causal/implicational relation) “B holds if A” extracted from a natural language sentence is represented by first-order predicate logic. An observation is a set of logical formulas in which a fact extracted from a natural language sentence is represented by first-order predicate logic.

Rules and observations have one or more literals. A literal is an atomic formula or an atomic formula containing a negation symbol. An atomic formula is one type of logical formula, and can be expressed as “p(t1, t2, . . . )”, where “p” is the predicate symbol and “t1, t2, . . . ” are the arguments. Literals can be represented as “install(user, software, pc)” and “!access(user, host)”, for example.

Predicate symbols represent relations and properties relating to objects. In the above-described example, the predicate symbols are “install” and “access”. The arguments are “user”, “software”, “pc”, and “host”. Also, arguments have constant symbols and variable symbols.

Constant symbols (constants) indicate individual objects that exist in the world to be represented. Constants are represented as character strings that begin with a capital letter or as character strings enclosed with double quotation marks (“ . . . ”), and variables are represented with character strings other than those representing constants. Constants are indicated by “RANSOM_PYLOCKY.A” and “iOS”, for example.

Variable symbols (variables) indicate objects of the world to be represented. Variables are used when an object is not specifically determined. Variables are indicated by “file”, for example.

Rules are logical formulas that are represented in a manner such as “P=>Q”. “P” on the left side indicates the antecedent, and “Q” on the right side indicates the consequent. “=>” indicates a causal/implicational relation. Note that “=>” not only allows for a strict implicational relation but also for a highly probable causal relation. Observations are logical formulas that are represented in a manner such as “P∧Q”.

“P” and “Q” are logical formulas. In this case, “!P”, “P∧Q”, “P∨Q” and “P=>Q” are also logical formulas. The logical symbol “∧” indicates conjunction, “∨” indicates disjunction, and “!” indicates negation. Note that “∀” (universal qualifier) and ∃ (existential qualifier) may be used as quantifiers.

Conversion to a logical formula will now be described. Conversion to a logical formula is based on the predicate-argument structure extracted from a natural language sentence. The predicate-argument structure is the structure between a predicate within the text of a natural language sentence and the plurality of arguments that are constituent elements of the concept expressed by the predicate.

Predicates as referred to here are expressions indicating operations, states, situations and modes, and in Japanese grammar declinable words such as verbs and adjectives and words formed by adding “suru” to nouns (eventive nouns) primarily correspond to the predicate. Arguments as referred to here are elements obligatory as participants in the actions or states represented by the predicates, and, in practice, noun phrases in case relations with respective predicates correspond to the arguments.

Also, with case relations between predicates and arguments, names corresponding to Japanese case particles such as “ga”, “wo” and “ni” are assigned based on the surface cases. Note that the predicate-argument structure conceivably conforms to the NAIST text corpus. The NAIST text corpus is, for example, described here: https://sites.google.com/site/naisttextcorpus/ntc-annotation-scheme.

For example, in the case of the natural language sentence “Taro eats an apple at 3 o'clock”, “eats” corresponds to the predicate, and “Taro”, “apple” and “3 o'clock” are respectively assigned as arguments corresponding to the “ga”, “wo” and “ni” cases. This results in the predicate-argument structure being a structure composed of the predicate and arguments in a case relation therewith.

The predicates each have obligatory cases (arguments) that must be present and optional cases (arguments) that are selectively present. Also, the type and number of obligatory cases is set for each predicate. For instance, with respect to the predicate “eat”, the information “who” and “what” are obligatory in principle. Thus, “ga” and “wo” are obligatory cases. In contrast, the information “when” and “where” is not absolutely necessary, and thus “ni” indicating time is an optional case.

With predicate symbols obtained by converting predicates into logical formulas, not only the type and number of arguments but also the order of those arguments is set. A predicate list indicating this convention has a correspondence relation between predicates and predicate symbols and information relating to the arguments for each predicate symbol. An operator performs conversion to literals based on the predicate-argument structure extracted from text, with reference to the predicate list. The predicate list enumerates the correspondence relations between predicates and predicate symbols corresponding to the respective predicates, and the type, number and order of the arguments are defined for each predicate symbol.

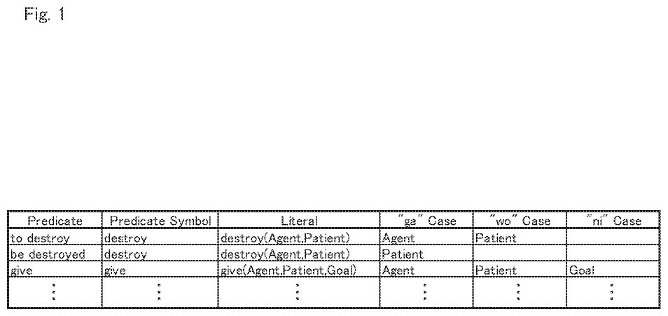

FIG. 1 is a diagram for describing an example of a predicate list. The example in FIG. 1 indicates that the predicates “kowasu” and “kowareru” in Japanese can be converted to the predicate symbol “destroy”. Also, the type of arguments related to the predicate symbol are defined by deep cases that are based on the meaning of cases such as “Agent” and “Patient”, rather than surface cases such as “ga” and “wo”. This is due to a divergence in the meaning expressed by the surface cases and deep cases depending on the predicates assigned to the same predicate symbol.

For example, in the case of the two situations “an attacker destroyed the HDD” and “the HDD is destroyed”, these two clauses indicate a common situation in which the “HDD” is “destroyed”. If the “ga” case is defined as the first argument of the predicate symbol “destroy” based on the surface case, the former clause will be “destroy(“attacker”, “HDD”)” and the latter clause will be “destroy(“HDD”, x1).”

This will result in the destroyed object “HDD” being assigned to the first argument in one clause and to the second argument in the other clause. In order to avoid this, the type of argument is defined by the deep case which is based on meaning.

The predicate list shown in FIG. 1 also shows the correspondence of surface cases and deep cases for each predicate symbol. The first argument of the predicate symbol “destroy” is assigned “Agent” indicating “what destroys”, and the second argument is assigned “Patient” indicating “what is destroyed”. When converted to literals with reference to the above, the former clause will be “destroy(“attacker”, “HDD”)” and the latter clause will be “destroy(x1, “HDD”), and the destroyed object “HDD” is assigned to the second argument of “destroy” in both cases. Note that predicates not defined in the predicate list do not need to be converted to literals.

An example of the definition of a deep case is shown next. The above-described “Agent” is an agent, experiencer or the like who performs a certain action or experiences a certain psychological event. Note that non-volitional actors are also agents. In principle, the “ga” case of transitive verbs and the “ga” case of some intransitive verbs (unergative intransitive verbs; intransitive verbs such as “run” and “cry” with respect to which the “ga” case can be interpreted as the agent) are the agents. For example, in the case of “penguins eat fish”, “disease claims lives” and “Taro cries”, “penguin”, “disease” and “Taro” are the “Agent”.

“Patient” is a patient, theme or the like, and is subjected to all manner of actions including being moved and changed, and, in principle, the “wo” case of transitive verbs and the “ga” case of some intransitive verbs (unaccusative intransitive verbs; intransitive verbs such as “be destroyed” and “continue” with respect to which the “ga” case can be interpreted as the patient; corresponding transitive verbs such as “to destroy” and “to continue” often exist). For example, in the case of “attack the server” and “continue to suffer damage”, “server” and “damage” are the “Patient”.

“Goal” is a goal, recipient or the like, and indicates an endpoint or state of movement of an object or the final state or result of a change in form. Note that “Goal” includes temporal and spatial endpoints. The “Goal” is primarily marked by the “ni” case of Japanese motion verbs. For example, in the case of “go to school” and “give to Taro”, “school” and “Taro” are the “Goal”.

Furthermore, “Source” indicates the origin or state of the movement of an object or the initial state of a change in form. Note that “Source” includes temporal and spatial origins. The “Source” is primarily marked by the “kara” case of Japanese motion verbs. For example, in the case of “download from a server” and “extract from a document”, “server” and “document” are the “Source”.

“Instrument” is a tool, means or the like, and is used, at the time of performing an action, for the purpose of achieving that action. The “Instrument” is primarily marked by the “de” case.

The procedure for constructing rules for inferential knowledge will now be described.

First, parts that are recognizable as causal/implicational relations (sentences/text serving as rule candidates) are specified from the text of a natural language sentence. Next, predicate-argument structures necessary for the rule candidates are extracted from the specified parts, and the extracted predicate-argument structures are each converted to a literal.

Next, the resultant literals are allocated to the antecedent or the consequent of the rule candidates. In the case where a plurality of literals are allocated to the antecedent and the consequent, the literals allocated to the antecedent and the literals allocated to the consequent are respectively concatenated by conjunctions “∧”, and then the antecedent and consequent and the antecedent and consequent are concatenated by the implication “=>”. Next, conversion is performed to a knowledge description format of inferential knowledge defined by the inference engine that is used.

Extraction of causal/implicational relations will now be described.

First, parts (rule candidates) that appear convertible to rules are specified from the given sentence. Specifically, parts where either an implicational relation or a causal relation is recognized between situations (events) are specified. Rule candidates are in principle assumed to be in units of single sentences, but may span a plurality of sentences. Also, depending on the information source, the antecedent may be determined in advance rather than being written in the text.

An implicational relation where “P=>Q” are in an implication relation refers to a relation in which “Q” always holds when “P” holds (“P” being a sufficient condition of “Q”). Conversely, “P” does not necessarily hold even if “Q” holds. In the case of an implicational relation, the temporal contextual relation between “P” and “Q” is not relevant. An example of an implicational relation might conceivably be “a PC generates heat when CPU usage increases.”

A causal relation where “P=>Q” are in a causal relation refers to a relation in which “P” already holds (or “P” is the main cause) if “Q” holds. “P” holding does not necessarily have to be a sufficient condition for “Q” holding, but does need to be a principal necessary condition. Note that, in the case of a causal relation, it is assumed that “Q” holds after “P” holds (including temporal contextual relations). An example of a causal relation might be, “A user may no longer be able to start up the system normally if the registry has been falsified.”

Conversion to literals will now be described.

Extraction of predicates and conversion of predicates to predicate symbols involves extracting predicates of a specified situation (event), and converting the extracted predicates to predicate symbols with reference to a predicate list.

Conversion to predicate symbols will now be described using the following sentence, “A user may no longer be able to start up the system normally if the registry has been falsified.”

First, the predicates “falsify” and “not be able to start up” are extracted from the above-described sentence. Then, the extracted predicates are converted to corresponding predicate symbols with reference to a predicate list. The predicate “falsify” is converted to the predicate symbol “falsify”, and the predicate “start up” is converted to the predicate symbol “start”.

Note that the predicate “falsify” is converted to the literal “falsify(agent, patient)”, and the predicate “start up” is converted to the literal “start(agent, patient)”. Because the original text is “no longer be able to start up”, however, a negation symbol is added to form the literal “!start(agent, patient)”.

The extraction of arguments related to predicates is defined in the predicate list, and thus the arguments necessary for the respective predicates are extracted with reference to the predicate list. Also, normalization of extracted arguments is performed by normalizing the extracted arguments with reference to an ontology having a work domain vocabulary (e.g., synonym dictionary, etc.).

Specifically, first, corresponding cases are extracted from the case structure defined for each predicate, with reference to the predicate list. If there are no corresponding cases, a variable unique within the rule is assigned. Basically, “x1, x2, . . . ”, for example, need only be assigned.

For example, in the case of the above-described sentence, “A user may no longer be able to start up the system normally if the registry has been falsified,” the first argument and second argument of the predicate symbol “falsify” are respectively defined as the “ga” case and “wo” case. Because the “ga” case (Agent, person doing the falsifying) of “falsify” is indeterminate, the variable “x1” is assigned. The “wo” case (Patient; object that is falsified) is analyzed as having been replaced by the “ga” case appearing on the surface of “falsified”, and “registry” is assigned.

Then, the notation is normalized by searching an ontology for the assigned argument, and taking the representative notation among the search results as the argument. Note that an entity whose search result is registered as a variable is taken as a variable.

In the case of “A user may no longer be able to start up the system normally if the registry has been falsified,” an ontology is searched for “registry”, and if retrieved as an entity, “registry” is taken as an argument in the case of “registry” being registered as the representative notation thereof. As a result, the literal “falsify(x1, “registry”)” is obtained.

When arguments are also extracted for “!start” and normalized using an ontology, the literal “!start(user, system)” is obtained. In the case where the ontology is searched for “user” and “system”, two entities are retrieved, and in the case where the two entities retrieved in the search are registered as variables, the two entities are taken as variables. The literal “!start(user, system)” is obtained as a result.

Construction of rules will now be described. First, after extracting literals from the rule candidates, the literals are each allocated to the antecedent or the consequent. If there is an implicational relation, the implicating side is taken as the antecedent and the implicated side is taken as the consequent. If there is a causal relation, the situation serving as the cause is taken as the antecedent and the situation serving as the effect is taken as the consequent. With the example, “A user may no longer be able to start up the system normally if the registry has been falsified”, the sentence is expressed as a rule such as “falsify(x1, “registry”)=>!start(user, system)”.

Note that, in the case where the sentence contains a plurality of conditions for the antecedent, consequent or both thereof to hold, or where a plurality of situations are written as adnominal modifier clauses, the literals are concatenated by conjunctions. For example, in the case of “A user who is logged in to the system may no longer be able to start up the system normally if the registry has been falsified and the password file has been deleted”, the sentence is expressed as a rule such as “falsify(x1, “registry”)∧delete(x2, “password file”)=>login(user, system)∧!start(user, system)”.

Also, if the antecedent, consequent or both thereof are written in parallel, rules equivalent in number thereto are enumerated. In the case of “A user may no longer be able to start up the system normally if the registry has been falsified and information was possibly stolen”, the sentence is enumerated as “falsify(x1, “registry”)=>!start(user, system)” and “falsify(x1, “registry”)=>steal(x2, information)”.

The construction of observations will now be described.

If natural language sentences contain facts that have been actually observed, information thereof is added as observations separately from the rules. Observations are also described as logical formulas, and a plurality of observations are concatenated by conjunctions. For example, in the case of “The username “HOGE” opened the attachment “seikyuu.docx” and it was confirmed that RANSOM_PYLOCKY.A is installed on the host “FUGA”, the sentence is represented as “open(“HOGE”, “seikyuu.docx”)∧install(“RANSOM_PYLOCKY.A”, “FUGA”)”.

Conversion to knowledge description format will now be described.

In the case where the rule is “falsify(x1, “registry”)=>!start(user, system)”, the rule is converted to “rule test{falsify(x1, “registry”)=>!start(user, system)}”, for example. Also, if the observation is “open(“HOGE”, “seikyuu.docx”)∧install(“RANSOM_PYLOCKY.A”, “FUGA”)”, the observation is converted to “problem test{observe{open(“HOGE”, “seikyuu.docx”)∧install(“RANSOM_PYLOCKY.A”, “FUGA”)}}”, for example.

Note that the task of constructing inferential knowledge involves extracting rules from contents written in an information source designated in advance, with regard to premise (antecedent) literals defined for each information source. At that time, depending on the type of information source, it is necessary for literals that are not explicitly written in a sentence to be added in advance to the antecedent of the rules as preconditions of the rules.

A technology for automating the construction of inferential knowledge will now be described.

Known technologies for automating the extraction of causal/implicational relations include Kloetzer et. al., 2015, “Large-Scale Acquisition of Entailment Pattern Pairs by Exploiting Transitivity”, for example, that involves using machine learning to acquire implicational pairs between language patterns from large documents (e.g., web data). Also, known technologies for acquiring causal relation pairs using machine learning include Hashimoto et. al., 2015, “Generating Event Causality Hypotheses through Semantic Relations” and Japanese Patent Laid-Open Publication No. 2018-060364.

However, with all the above-described technologies, the antecedent and consequent that are acquired are only those in relations between single events, and only causal relations between single events (relations A=>B) are targeted, and thus causal relations in which the antecedent, consequent or both thereof consist of a plurality of events (e.g., A∧C∧D=>B, A∧B=>C∧D, etc.) cannot be acquired. That is, fully automatic and accurate extraction of causal/implicational relations is not possible.

Known technologies for automating conversion to literals include Bos et al., 2004, “Wide-Coverage Semantic Representations from a CCG Parser”, in COLING '04, for example. Also, known techniques for utilizing predicate-argument structure analysis as a method of conversion to literals include Kazuaki Inada, Yuichiro Matsubayashi, Naoya Inoue, Kentaro Inui, “Toward Logical Conversion of Japanese Sentences for Efficient Inference Processing”, Proceedings of 2013 National Meeting of the Association for Natural Language Processing, https://sites.google.com/site/yoTarow/chapas, and Tomohide Shibata et al., 2016, “Neural Network-Based Model for Japanese Predicate Argument Structure Analysis”, ACL 2016, for example.

However, the accuracy of the above-described predicate structure analysis is not high. Also, this predicate-argument structure analysis works well in simple cases where case particles appear explicitly, but fails in complex cases where case particles are omitted or where cases are replaced due to the passive voice or the like. That is, the accuracy of conventional predicate-argument structure analysis does not allow for fully automatic and accurate conversion to literals.

Also, since inaccurate literals created by errors in predicate-argument structure analysis are carried over, inadequate rules are generated for respective antecedents and consequents.

In this way, the above-described technology does not allow for rules covering literals necessary for rules to be generated fully automatically. Thus, inaccurate and inadequate rules must be corrected manually, which takes time and effort.

Also, in the case where the task of converting predicate-argument structures to literals is performed manually, the operator is required to have specialized knowledge relating to the domain to be constructed, knowledge of natural language processing (predicate-argument structures), and knowledge relating to the specifications of literals.

Also, if a rule contains an erroneous literal, the rule needs to be edited, and if a rule contains a deficient literal, a literal corresponding to the natural sentence serving as the original sentence need to be added with reference to the original sentence.

Furthermore, in the case of conversion to predicate symbols and normalization of arguments, the operator needs to construct rules in accordance with the specifications of the literals of inferential knowledge of the object, with reference to a correspondence table (predicate list) of predicates, predicate symbols and cases, an ontology (synonym dictionary) and the like.

In view of this, in order to solve the above-described problems, the inventors arrived at an invention that supports the task of editing rules, in order to improve the work efficiency of inferential knowledge construction. That is, the inventors realized that, since there are often conditions to be added or corrected that neighbor places (sentences/text serving as rule candidates) corresponding to natural language sentences, rules can be easily edited (added, corrected, etc.) by also presenting the natural language sentences of neighboring portions in literalized form for the operator to refer to.

Specifically, a user interface is provided that allows the operator to freely edit (add, correct, delete, etc.) neighboring literals in rule candidates, and that can, furthermore, normalize the predicate symbols and arguments of literals, by juxtaposing a list of rule candidates consisting of inaccurate and inadequate literals with a list of literals of neighboring parts on a display device.

Furthermore, the inventors arrived at an invention that supports the task of editing observations, in order to improve the work efficiency of inferential knowledge construction. That is, a user interface is provided that allows the operator to freely edit (add, correct, delete, etc.) neighboring literals in observation candidates, and that can, furthermore, normalize the predicate symbols and arguments of literals, by juxtaposing a list of observations consisting of inaccurate and inadequate literals with a list of literals of neighboring parts on a display device.

### EXAMPLE EMBODIMENTS

Hereinafter, an example embodiment of the invention will be described with reference to FIGS. 1 to 17.

[Apparatus Configuration]

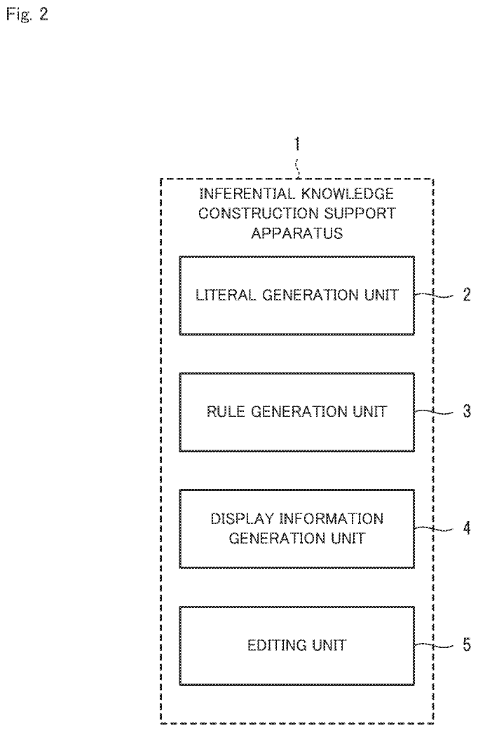

Initially, the configuration of an inferential knowledge construction support apparatus 1 in the example embodiment will be described using FIG. 2. FIG. 2 is a diagram for describing an example of the inferential knowledge construction support apparatus.

The inferential knowledge construction support apparatus 1 shown in FIG. 2 is an apparatus that provides support allowing for inferential knowledge to be efficiently constructed. Also, as shown in FIG. 2, the inferential knowledge construction support apparatus 1 has a literal generation unit 2, a rule generation unit 3, a display information generation unit 4, and an editing unit 5.

Of these, the literal generation unit 2 extracts elements corresponding to predicate symbols and arguments from descriptive information indicating a natural sentence (sentence/text in natural language or sentence), and generates literal information based on the extracted elements. The rule generation unit 3 estimates causal/implicational relations between literals, using plural pieces of literal information, and generates rule information (rule candidate) by allocating literal information estimated to be in a causal/implicational relation to the antecedent and the consequent.

The display information generation unit 4 generates display information to be used for outputting, on a display device, a rule editing user interface for displaying, in a juxtaposed manner, a literal display area for displaying literal information and descriptive information corresponding to the literal information and a rule display area for displaying rule information and descriptive information corresponding to the rule information. The editing unit 5 enables the operator to edit the rule information (rule candidates), using the rule editing user interface.

In this way, in the example embodiment, rules displayed in the rule display area can be edited using literals displayed in the literal display area, thus enabling the operator to efficiently construct inferential knowledge.

The user interface will now be described.

A rule editing user interface 20 is a display that is used for efficiently constructing inferential knowledge and is displayed on the screen of a display device. Also, the rule editing user interface 20 can be operated by the operator using an operation device such as a mouse, a keyboard and a touch panel. Operations are various operations that use a keyboard, a mouse, a touch panel, voice input and the like, using onscreen visual elements (graphical information), for example.

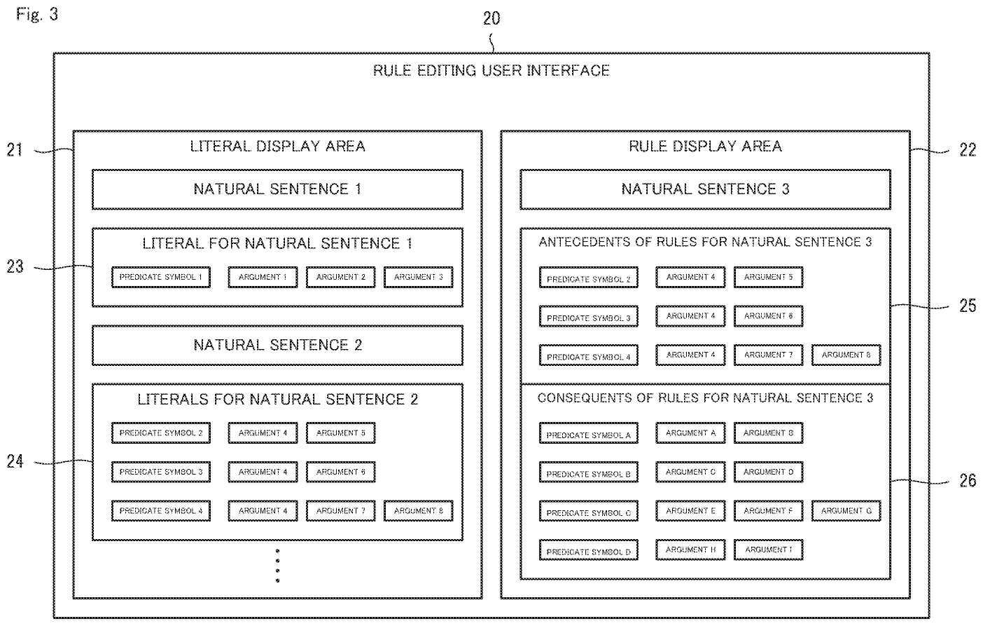

FIG. 3 is a diagram for describing an example of this user interface. Specifically, the rule editing user interface 20 displays a literal display area 21 and a rule display area 22 such as shown in FIG. 3 on the screen of a display device in a juxtaposed manner.

In the literal display area 21, natural sentences and literals for the natural sentences are displayed. In the example in FIG. 3, a natural sentence 1 and a literal 23 for the natural sentence 1 and a natural sentence 2 and literals 24 for the natural sentence 2 are shown. The literal 23 for the natural sentence 1 is shown as a literal constituted by [predicate symbol 1, argument 1, argument 2, argument 3]. The literals 24 for the natural sentence 2 are shown as three literals [predicate symbol 2, argument 4, argument 5], [predicate symbol 3, argument 4, argument 6], and [predicate symbol 4, argument 4, argument 7, argument 8] concatenated by conjunctions “∧”.

In the rule display area 22, a natural sentence and literals serving as the antecedent and consequent of rules for the natural sentence are displayed. In the example in FIG. 3, a natural sentence 3 and literals serving as the antecedent and consequent of rules for the natural sentence 3 are shown. In an antecedent display area 25, three literals [predicate symbol 2, argument 4, argument 5], [predicate symbol 3, argument 4, argument 6], and [predicate symbol 4, argument 4, argument 7, argument 8] concatenated by conjunctions “∧” are shown. In a consequent display area 26, four literals [predicate symbol A, argument A, argument B], [predicate symbol B, argument C, argument D], [predicate symbol C, argument E, argument F, argument G], and [predicate symbol D, argument H, argument I] concatenated by conjunctions “∧” are shown.

In this way, by using the rule editing user interface 20 of the example embodiment, the operator is able to correct literals of the antecedent display area 25 or literals of the consequent display area 26 of rules displayed in the rule display area 22, with reference to literals displayed in the literal display area 21, even in the case where rule information (rule candidates) that includes erroneous literal information is generated. Thus, it is possible to improve both the work efficiency and accuracy with which inferential knowledge is constructed.

Also, by using the rule editing user interface 20 of the example embodiment, rule information can be easily corrected, even if the operator who corrects the rule information is not as knowledgeable as operators in the past.

Also, conventionally, in the case where a rule contained a deficient literal, the operator added a literal corresponding to the natural sentence with reference to the natural sentence. However, in the example embodiment, the operator is able to easily correct rules with reference to the natural sentence corresponding to literals displayed in the literal display area 21.

Furthermore, due to the improved work efficiency of the operator, the work cost required to correct erroneous literals can be reduced. Also, by using the rule editing user interface 20, the state of editing can be visualized, thus enabling work errors by the operator to be reduced.

[System Configuration]

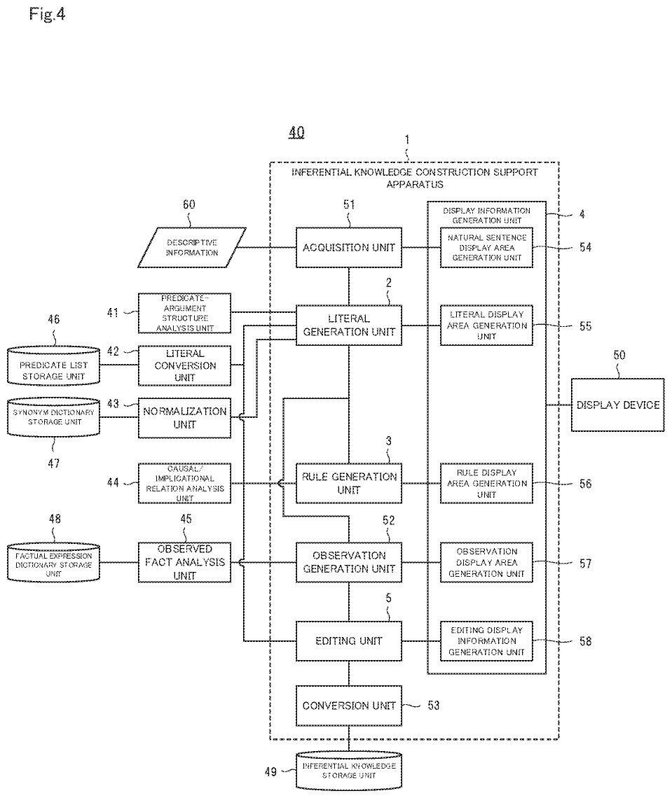

Next, the configuration of the inferential knowledge construction support apparatus 1 in the example embodiment will be described more specifically using FIG. 4. FIG. 4 is a diagram showing an example of a system having the knowledge construction support apparatus.

In addition to the inferential knowledge construction support apparatus 1, a system 40 shown in FIG. 4 includes a predicate-argument structure analysis unit 41, a literal conversion unit 42, a normalization unit 43, a causal/implicational relation analysis unit 44, an observed fact analysis unit 45, a predicate list storage unit 46, a synonym dictionary storage unit 47, a factual expression dictionary storage unit 48, an inferential knowledge storage unit 49, and a display device 50.

The inferential knowledge construction support apparatus 1 is conceivably an information processing apparatus such as a server computer or a personal computer. The predicate list storage unit 46, the synonym dictionary storage unit 47, the factual expression dictionary storage unit 48 and the inferential knowledge storage unit 49 are storage devices such as databases. In the example in FIG. 4, the above-described storage units 46 to 49 are provided outside the inferential knowledge construction support apparatus 1, but may be provided inside the inferential knowledge construction support apparatus 1. Also, there may be one storage device or a plurality of storage devices.

The inferential knowledge construction support apparatus 1 has an acquisition unit 51, an observation generation unit 52 and a conversion unit 53, in addition to the literal generation unit 2, the rule generation unit 3, the display information generation unit 4 and the editing unit 5. The display information generation unit 4 has a natural sentence display area generation unit 54, a literal display area generation unit 55, a rule display area generation unit 56, an observation display area generation unit 57 and an editing display information generation unit 58.

The inferential knowledge construction support apparatus will now be described.

The acquisition unit 51 acquires descriptive information 60 corresponding to a natural sentence (sentence/text of natural language sentence) selected by the operator. Specifically, the descriptive information 60 is text acquired from a URL (Uniform Resource Locator) destination related to target inferential knowledge, text acquired from an HTML (HyperText Markup Language) file or the like.

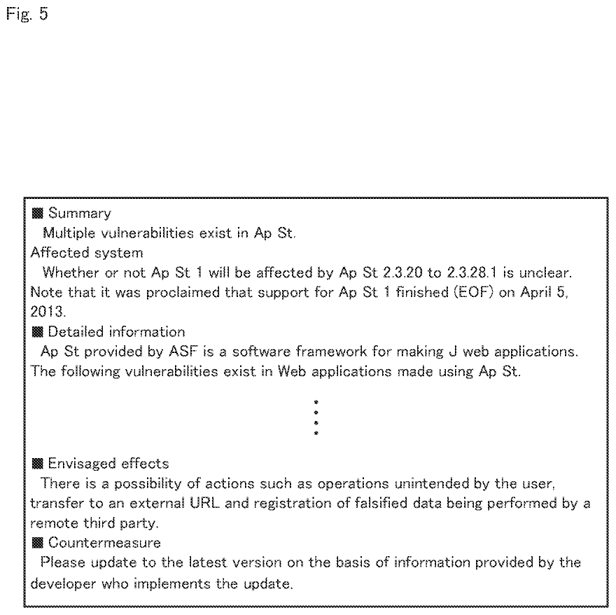

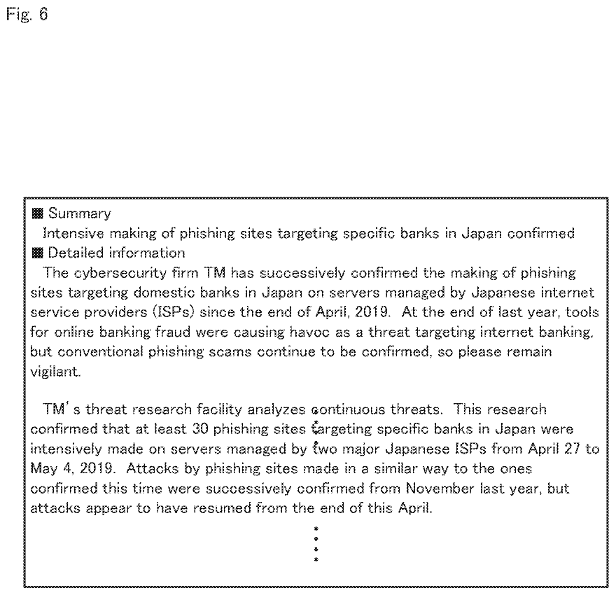

FIGS. 5 and 6 are diagrams for describing examples of natural sentences. In the case of constructing inferential knowledge relating to information security measures, it is conceivable to acquire natural sentences such as shown in FIGS. 5 and 6 from vulnerability countermeasure information portal sites and the like that are useful for information security measures that provide vulnerability-related information such as software and countermeasure information, for example.

The literal generation unit 2 extracts elements corresponding to the predicate symbol and arguments from the descriptive information corresponding to the selected natural sentence, and generates literal information indicating literals based on the extracted elements. Specifically, the literal generator unit 2 generates literal information, using the predicate-argument structure analysis unit 41, the literal conversion unit 42, the normalization unit 43, the predicate list storage unit 46 and the synonym dictionary storage unit 47.

Note that, in the example in FIG. 4, the predicate-argument structure analysis unit 41, the literal conversion unit 42 and the normalization unit 43 are provided outside the inferential knowledge construction support apparatus 1, but may be provided in the inferential knowledge construction support apparatus 1. Also, the predicate-argument structure analysis unit 41, the literal conversion unit 42 and the normalization unit 43 are conceivably information processing apparatuses such as server computers and personal computers. Furthermore, the predicate-argument structure analysis unit 41, the literal conversion unit 42 and the normalization unit 43 may be constituted using one or a plurality of information processing apparatuses.

The predicate-argument structure analysis unit 41 analyzes the predicate-argument structure of the natural sentence and extracts the predicate and arguments of the predicate-argument structure. Specifically, the predicate-argument structure analysis unit 41 first acquires descriptive information 60 from the literal generation unit 2. Then, the predicate-argument structure analysis unit 41 analyzes the predicate-argument structure of the natural sentence and extracts the predicate and arguments of the predicate-argument structure.

In the case of Japanese, the predicate-argument structure analysis unit 41 performs dependency parsing on the descriptive information corresponding to the natural sentence, using a Japanese language dependency parser such as CaboCha (Japanese dependency parser based on SVMs (Support Vector Machines), for example. In addition, the predicate-argument structure analysis unit 41 analyzes the predicate-argument structure using a Japanese language predicate-argument structure analyzer such as ChaPAS, for example. Also, the predicate-argument structure analysis unit 41 specifies sentences written as a causal relation and classifies the affirmation/negation of the predicate, using a modality analysis engine such as Zunda, for example.

In the case of English, the predicate-argument structure analysis unit 41 conceivably uses Allen NLP (Natural Language Processing), which is one of the open source NLP libraries, as a language analysis tool, for example. Specifically, the predicate-argument structure analysis unit 41 extracts the predicate-argument structure, using a constituency parsing function and a semantic role parsing function.

Note that, similarly for languages other than Japanese and English, predicate-argument structure analysis need only be performed using an open source language analysis tool, for example.

The literal conversion unit 42 performs conversion to literal information using the predicate and arguments of the extracted predicate-argument structure. Specifically, the literal conversion unit 42 first acquires the predicate extracted by the predicate-argument structure analysis unit 41. Then, the literal conversion unit 42 refers to the predicate list information that is stored in the predicate list storage unit 46, using the acquired predicate, and selects information indicating a predicate symbol and grammatical cases corresponding to the predicate. A grammatical case is information related to surface cases and deep cases in the case of Japanese, for example.

Predicate list information is, for example, a table in which information indicating predicate symbols and grammatical cases is respectively associated with information indicating predicates. For example, a data structure table as shown in FIG. 1 is conceivable.

Also, the literal conversion unit 42 refers to the predicate list information, and, based on the case structure defined for each predicate, extracts arguments necessary for the predicate from the descriptive information 60.

Furthermore, the literal conversion unit 42 also converts the arguments to variables. Specifically, the literal conversion unit 42 first refers to the predicate list information, and, if there are no cases corresponding to the case structure defined for each predicate, assigns a variable unique within the rule.

The normalization unit 43 normalizes the arguments necessary for the extracted predicate. Specifically, the normalization unit 43 first acquires an argument extracted by the literal conversion unit 42. Then, the normalization unit 43 searches the synonym dictionary information that is stored in the synonym dictionary storage unit 47 using the acquired argument, and normalizes the argument by taking the representative notation from the search results as an argument.

Synonym dictionary information is, for example, a table in which class and information indicating synonymous relations are associated with entities.

The rule generation unit 3 specifies causal/implicational relations from descriptive information corresponding to the selected natural sentence, and generate rule candidates by allocating literal information corresponding to specified sentences to the antecedent and the consequent. Specifically, first, the rule generation unit 3 transmits descriptive information 60 to the causal/implicational relation analysis unit 44. Then, the rule generation unit 3 causes the causal/implicational relation analysis unit 44 to specify causal/implicational relations, using the descriptive information 60. Then, the rule generation unit 3 acquires specification results from the causal/implicational relation analysis unit 44.

The causal/implicational relation analysis unit 44 specifies sentences written as causal/implicational relations, using analysis results of Zunda or the results of matching with conditional clauses of regular expressions, for example, and allocates literals corresponding to specified sentences to the antecedent and the consequent.

The observation generation unit 52 estimates literal information corresponding to observed facts, using plural pieces of literal information, and generates the estimated literal information as observation information (observation candidates) corresponding to the observed facts. Specifically, first, the observation generation unit 52 transmits descriptive information 60 to the observed fact analysis unit 45. Then, the observation generation unit 52 causes the observed fact analysis unit 45 to specify observed facts, using the descriptive information 60. Then, the observation generation unit 52 acquires specification results from the observed fact analysis unit 45.

The observed fact analysis unit 45 specifies sentences written as observed facts with reference to factual expression dictionary information that is stored in the factual expression dictionary storage unit 48. Factual expression dictionary information is information in which expressions such as “ . . . was observed“and” . . . was confirmed” are enumerated.

The display information generation unit 4 generates display information for displaying, on the screen of the display device 50, at least user interfaces that are used for editing inferential knowledge (rule information, observation information). Specifically, the display information generation unit 4 generates display information to be used for displaying user interfaces on the screen of the display device 50, using the natural sentence display area generation unit 54, the literal display area generation unit 55, the rule display area generation unit 56 and the observation display area generation unit 57.

The display information generation unit 4 generates display information to be used for causing the display device 50 to output a rule editing user interface for displaying, in a juxtaposed manner, a literal display area for displaying literal information and descriptive information corresponding to the literal information and a rule display area for displaying rule information and descriptive information corresponding to rule information.

Also, the display information generation unit 4 generates display information to be used for causing the display device 50 to output an observation editing user interface for displaying, in a juxtaposed manner, a literal display area and a rule display area for displaying observation information and descriptive information corresponding to observation information.

The natural sentence display area generation unit 54 generates display information to be used for displaying a natural sentence display area for displaying natural sentences on the screen of the display device 50. Specifically, first, the natural sentence display area generation unit 54 acquires descriptive information 60 from the acquisition unit 51. Then, the natural sentence display area generation unit 54 generates display information that is for displaying natural sentences corresponding to the descriptive information 60 in a display area (visual element such as a window).

The literal display area generation unit 55 generates display information to be used for displaying a literal display area for displaying literals and natural sentences corresponding to the literals on the screen of the display device 50. Specifically, first, the literal display area generation unit 55 acquires literal information from the literal generation unit 2. Then, the literal display area generation unit 55 generates display information that is for displaying natural sentences and literals corresponding to the literal information in a display area.

The rule display area generation unit 56 generates display information to be used for displaying a rule display area for displaying rules and the natural sentence corresponding to the rules on the screen of the display device 50. Specifically, first, the rule display area generation unit 56 acquires rule information from the rule generation unit 3. Then, the rule display area generation unit 56 generates display information that is for displaying natural sentences and rules corresponding to the rule information in a display area.

The observation display area generation unit 57 generates display information to be used for displaying an observation display area for displaying observations and natural sentences corresponding to observations on the screen of the display device 50. Specifically, first, the observation display area generation unit 57 acquires observation information from the observation generation unit 52. Then, the observation display area generation unit 57 generates display information for displaying natural sentences and rules corresponding to the rule information in a display area.

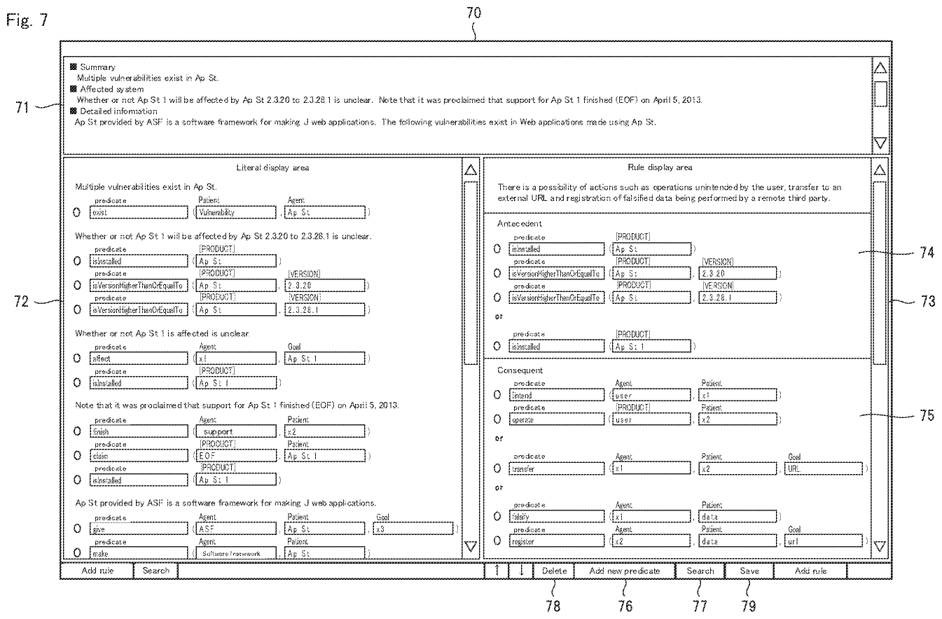

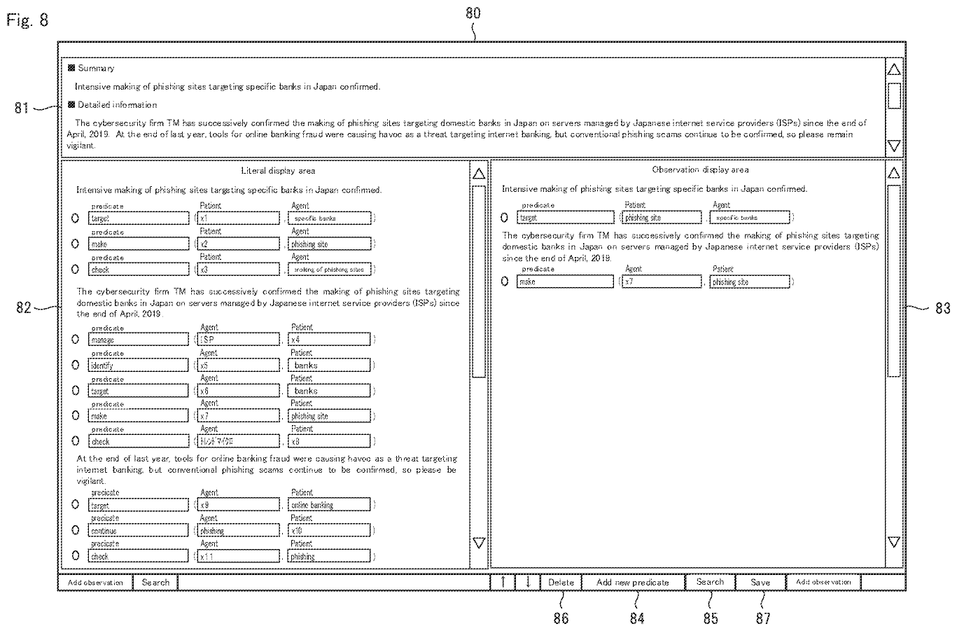

The display modes of the display areas will now be described using FIGS. 7 and 8. FIG. 7 is a diagram for describing an example in which a natural sentence display area, a literal display area and a rule display area are displayed. FIG. 8 is a diagram for describing an example in which a natural sentence display area, a literal display area and an observation display area are displayed.

The display information generation unit 4 displays a rule editing user interface 70 on the screen of the display device 50, as shown in FIG. 7, for example. On the rule editing user interface 70 are displayed a natural sentence display area 71, a literal display area 72 and a rule display area 73. Also, the display information generation unit 4 displays an observation editing user interface 80 on the screen of the display device 50, as shown in FIG. 8, for example. On the observation editing user interface 80 are displayed a natural sentence display area 81, a literal display area 82 and an observation display area 83.

The editing display information generation unit 58 generates display information to be used for displaying display information indicating visual elements (e.g., windows, checkboxes, text boxes, buttons, icons, scroll bars, etc.) necessary in editing on the screen of the display device 50.

The display device 50 acquires display information converted to a displayable format by the display information generation unit 4, and outputs generated images or the like, based on the acquired display information. The display device 50 is an image display device that uses liquid crystal, organic EL (Electro Luminescence) or CRTs (Cathode Ray Tubes), for example. Furthermore, the image display device may include an audio output device such as a speaker.

The editing unit 5 acquires information relating to an editing operation of a rule or observation carried out by the operator, using the user interface displayed on the screen of the display device 50 and an operation device, and generates rule information or observation information, based on the acquired information. Specifically, the editing unit 5 enables the operator to edit the rule information, using the rule editing user interface. Also, the editing unit 5 enables the operator to edit the observation information, using the observation editing user interface.

Editing of rule information includes (1) editing for adding a literal to a rule, (2) editing for deleting a literal from a rule, and (3) editing the logical structure of a rule, for example. Also, editing of observation information includes (4) editing for adding a literal to an observation and (5) editing for deleting a literal from an observation.

(1) Editing for Adding Literal to Rule

(1-1) Editing Rule with Literal Selected from Literal Display Area

Rules that are displayed in the rule display area 73 are automatically generated, and thus needs to be corrected through editing by the operator. In view of this, the operator selects a literal from the plurality of literals displayed in the literal display area 72, and adds the selected literal to an antecedent display area 74 or a consequent display area 75 of the rule display area 73.

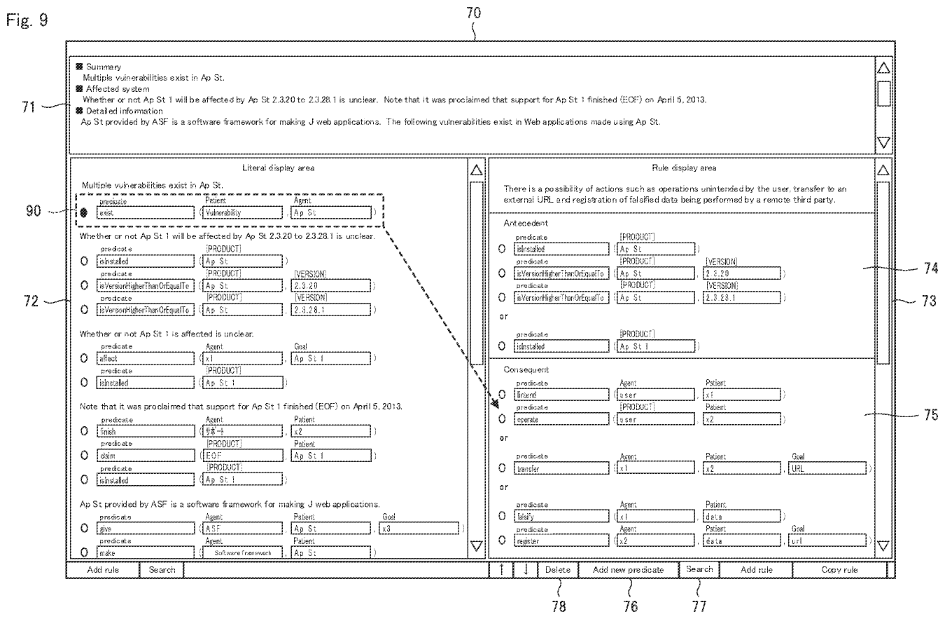

FIG. 9 is a diagram for describing an example of editing for adding a literal to a rule. In the example in FIG. 9, the operator, through an operation using an operation device such as a mouse, selects (drags) a literal 90 (broken line region) displayed in the literal display area 72, and adds (drops) the literal 90 to the consequent display area 75 of the rule display area 73.

(1-2) Adding New Literal to Rule

First, upon a predicate being input to a predicate input area of the rule editing user interface, the editing unit 5 refers to the predicate list information using the input predicate, and searches for information indicating a predicate symbol and grammatical cases corresponding to the predicate. Thereafter, the display information generation unit 4 generates display information to be used for displaying information indicating the predicate symbol and grammatical cases retrieved in the search in the predicate input area.

Specifically, in the case of adding a new literal to the antecedent display area or consequent display area of the rule display area, in the example in FIG. 7, after selecting the antecedent display area 74 or the consequent display area 75 to which the new literal is to be added, the operator displays the predicate input area in the rule display area 73 by pressing a button 76 that is used for adding a new predicate.

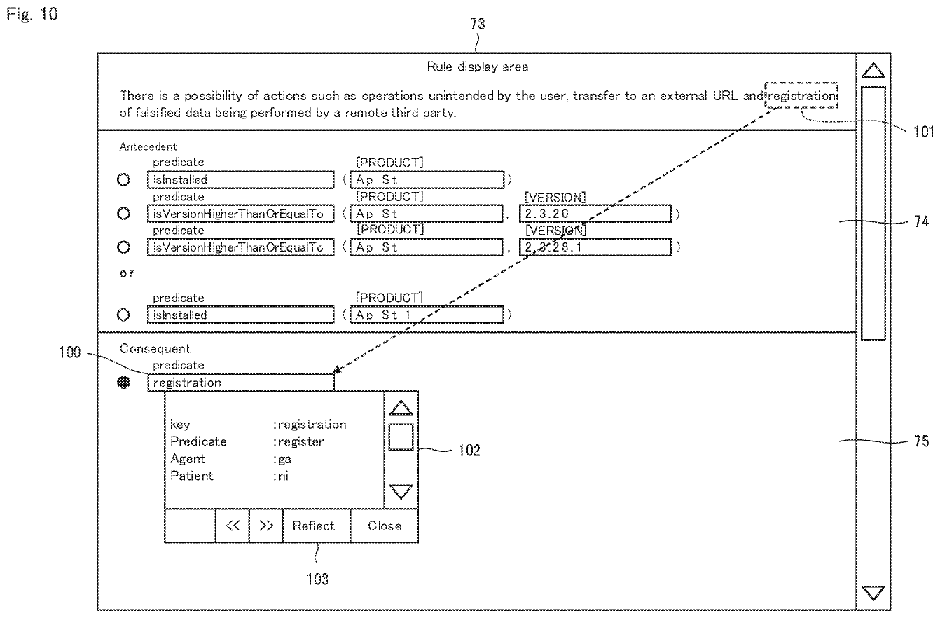

FIGS. 10, 11, 12 and 13 are diagrams for describing an example of editing for adding a new literal to a rule. In the example in FIG. 10, description will be given using a state in which there are no existing literals, in order to facilitate understanding. In the example in FIG. 10, first, “register” is input as text by the operator to a predicate input area 100 (area below predicate) of the consequent display area 75. Note that “registration” 101 that is displayed in the natural sentence display area 71 or the rule display area 73 may be copied and pasted to the predicate input area 100, using an operation device.

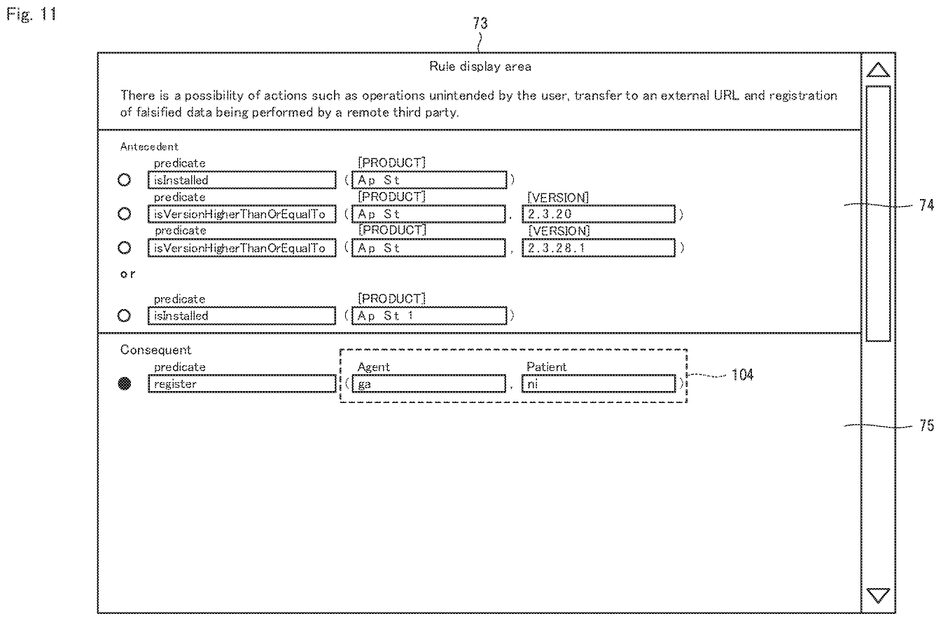

Next, when the operator presses a button 77 shown in FIG. 7 that is used for performing a search, the predicate list information is searched with “register” as the search key. If a predicate symbol corresponding to “register” is retrieved in the search, a display 102 indicating the predicate structure such as shown in FIG. 10 is displayed. Thereafter, when the operator presses a button 103 that is used for reflecting the contents of the display 102 in the consequent display area 75, an argument input area 104 that is used for inputting arguments is displayed as shown in FIG. 11.

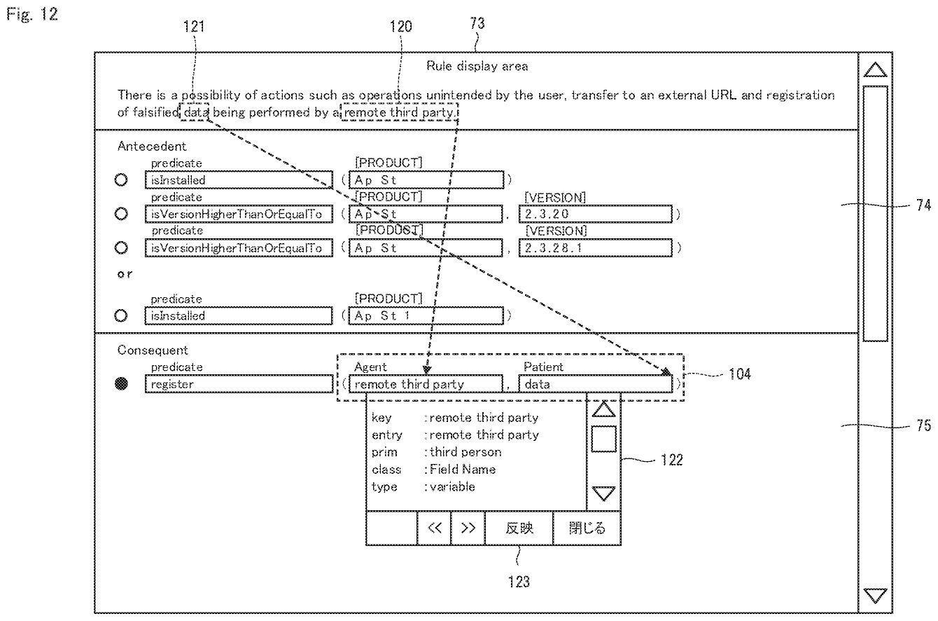

Next, the operator inputs arguments to the argument input area 104. In the example in FIG. 12, the operator inputs “remote third party” and “data” to the argument input area 104 of the consequent display area 75. Note that the operator may copy and paste “remote third party” 120 and “data” 121 that are displayed in the natural sentence display area 71 or the rule display area 73 to the argument input area 104.

Next, the operator normalizes the arguments. Upon arguments being input to the argument input area of the rule editing user interface, the editing unit 5 refers to synonym dictionary information using the input arguments, and normalizes the input arguments. Thereafter, the display information generation unit 4 generates display information to be used for displaying the normalized arguments in the argument input area.

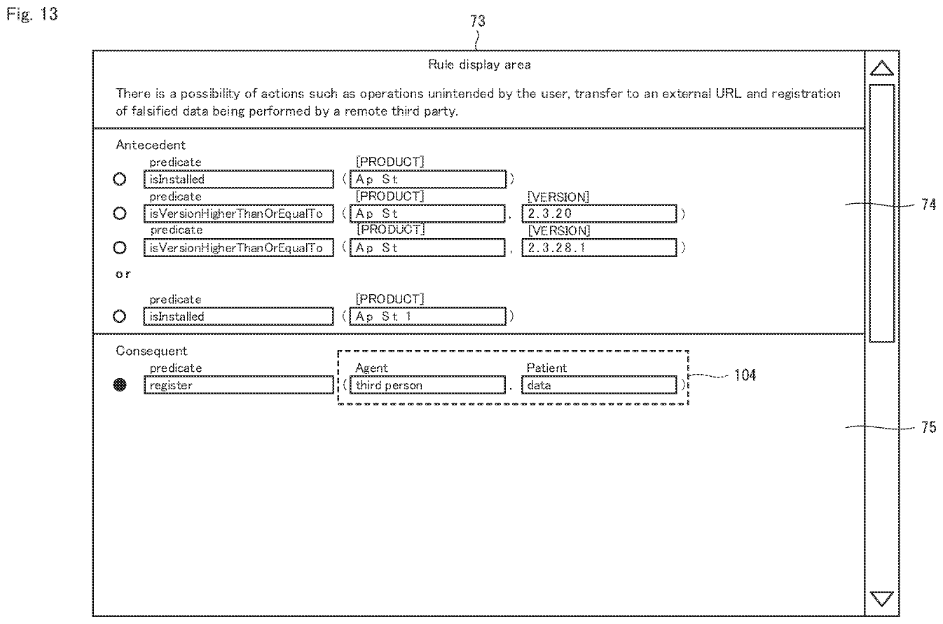

In the example in FIG. 12, when the operator presses the button 77 that is used for performing a search in the case where “remote third party” is selected, synonym dictionary information is searched with “remote third party” as the search key. If an entity corresponding to “remote third party” is retrieved in the search, a display 122 such as shown in FIG. 12 is displayed. Thereafter, the operator presses a button 123 that is used for reflecting the contents of the display 122 in the consequent display area 75. Once normalization is implemented on “remote third party” and “data”, the arguments “remote third party” and “data” of the argument input area 104 are converted to the normalized arguments “third party” and “data” shown in the argument input area 104 of FIG. 13.

(2) Editing for Deleting Literal from Rule

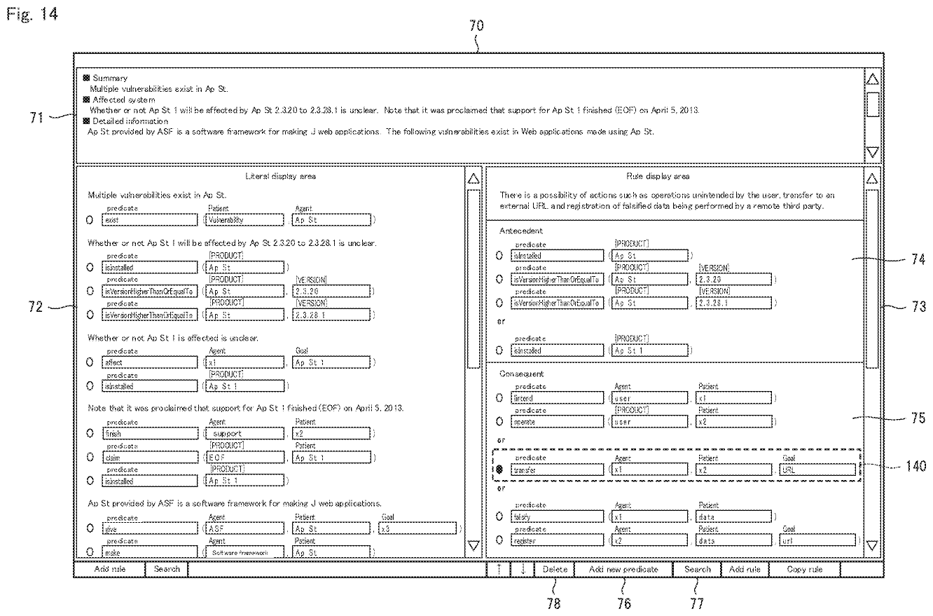

FIG. 14 is a diagram for describing an example of editing for deleting a literal from a rule. In the case of deleting a literal from the antecedent display area 74 or the consequent display area 75 of the rule display area 73, the operator selects the deleted literal. In the example in FIG. 14, a literal 140 has been selected using a checkbox (filled circle). Thereafter, when a button 78 that is used for performing deletion is pressed by the operator, the selected literal 140 is deleted from the consequent display area 75 and no longer displayed.

(3) Editing Logical Structure of Rule

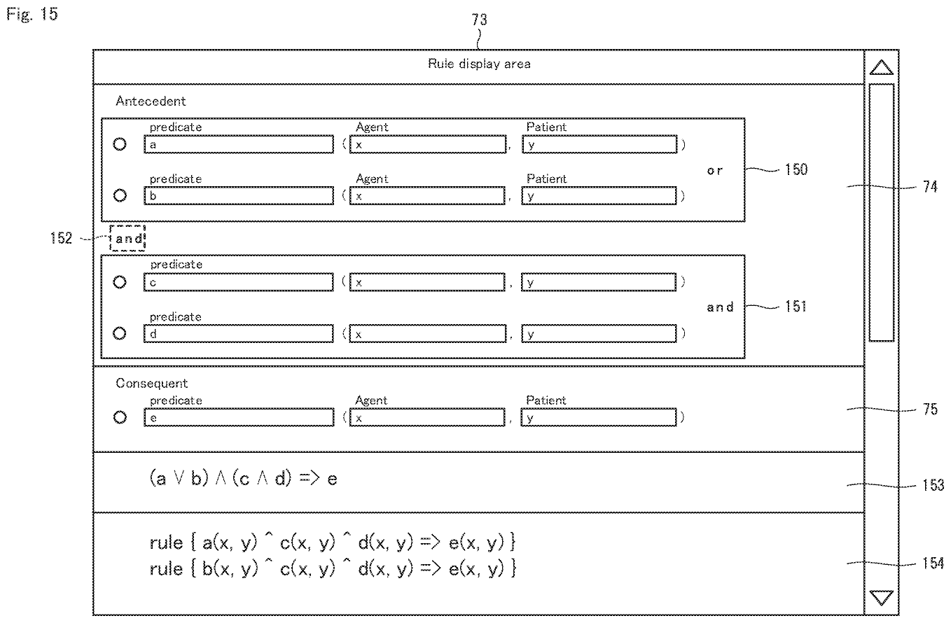

FIG. 15 is a diagram for describing an example of editing the logical structure of a rule. The logical relation of a literal is represented by AND and OR blocks and the logical relation between the blocks. For example, in the case where the rule is the logical formula (a∨b)∧(c∧d)=>e, (a∨b) and (c∧d) are respectively displayed in an OR block display area 150 and an AND block display area 151 of the rule display area 73. Note that the characters “or” and “and” may be displayed within the blocks as shown in FIG. 15 or the area may be divided by different colors, so that the OR block display area and the AND block display area can be visually distinguished.

The logical relation between the blocks is displayed by the logical symbol “and” or “or” being assigned. In the example in FIG. 15, “and” is displayed in a logical relation display area 152 as a display indicating the logical relation between the blocks.

Note that a configuration may be adopted in which literals that are displayed in the block display area can be divided, combined and deleted. A configuration may also be adopted in which block display areas can be added. Also, a configuration may be adopted in which a logical relation display area 153 for displaying a logical relation between the blocks such as shown in FIG. 15 can be displayed. Furthermore, a configuration may be adopted in which a format conversion display area 154 for displaying a formula obtained by a logical formula such as shown in FIG. 15 being expanded and converted to David format can be displayed.

(4) Editing for Adding Literal to Observation

(4-1) Editing Observation with Literal Selected from Observation Display Area

As shown in FIG. 8, the observations that are displayed in the observation display area 83 are automatically generated, and thus need to be corrected through editing by the operator. In view of this, the operator selects a literal from the plurality of literals displayed in the literal display area 82, and adds the selected literal to the observation display area 83.

Specifically, the operator, through an operation using an operation device such as a mouse, selects (drags) a literal displayed in the literal display area 82 and adds (drops) the selected literal to the observation display area 83.

(4-2) Adding New Literal to Observation

First, upon a predicate being input to a predicate input area of the observation editing user interface, the editing unit 5 refers to the predicate list information using the input predicate, and searches for information indicating a predicate symbol and grammatical cases corresponding to the predicate. Thereafter, the display information generation unit 4 generates display information to be used for displaying information indicating the predicate symbol and grammatical cases retrieved in the search in the predicate input area.

Specifically, in the example in FIG. 8, in the case of adding a new literal to the observation display area, the operator displays the predicate input area in the observation display area 83 by pressing a button 84 that is used for adding a new predicate.

Next, a predicate is input as text by the operator to the predicate input area, similarly to when editing a rule. Note that a predicate that is displayed in the natural sentence display area 81 or the observation display area 83 may be copied and pasted to the predicate input area, using an operation device.

Next, when a button 85 shown in FIG. 8 that is used for performing a search is pressed, the predicate list information is searched with the input predicate as the search key. If a predicate symbol corresponding to the input predicate is retrieved in the search, the predicate structure is displayed.

Next, the operator normalizes the arguments. When arguments are input in the argument input area of the observation editing user interface, the editing unit 5 refers to synonym dictionary information using the input arguments, and normalizes the input arguments. Thereafter, the display information generation unit 4 generates display information to be used for displaying the normalized arguments in the argument input area.

Specifically, a new literal is added to the observation display area 83 by performing operations similarly to (1-2) described above.

(5) Editing for Deleting Literal from Observation

In the case of deleting a literal from the observation display area 83, the operator selects the deleted literal. When the operator presses a button 86 that is used for performing deletion, after selecting a literal using a checkbox (filled circle), the selected literal is deleted from the observation display area 83 and no longer displayed.

The conversion unit 53 converts the edited rule information or observation information to a format for an automatic inference engine and stores the resultant information in the inferential knowledge storage unit 49. Specifically, first, the conversion unit 53 acquires rule information or observation information generated by the editing unit 5. Then, the conversion unit 53 converts the acquired rule information or observation information to an automatic inference engine format. Thereafter, the conversion unit 53 stores the information converted to an automatic inference engine format in the inferential knowledge storage unit 49.

[Apparatus Operations]

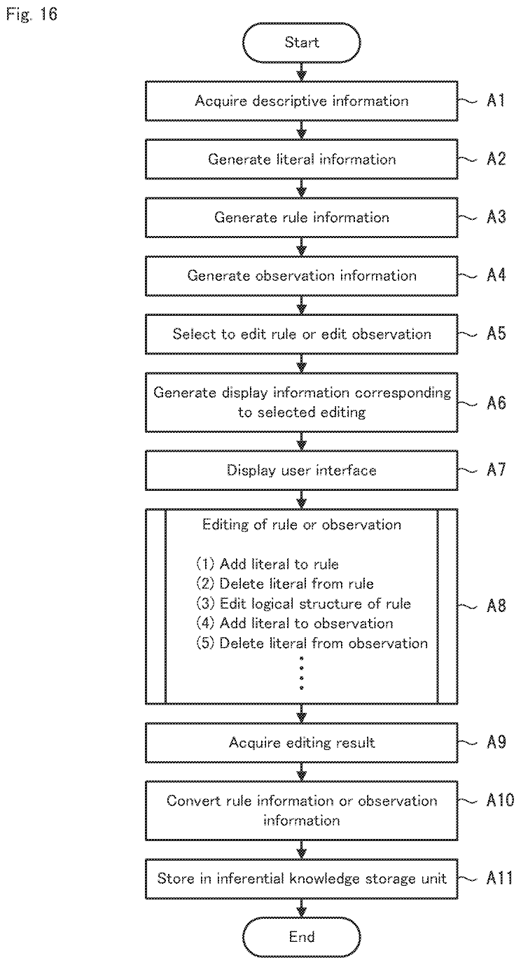

Next, operations of the inferential knowledge construction support apparatus of the example embodiment of the invention will be described using FIG. 16. FIG. 16 is a diagram for describing an example of the operations of the inferential knowledge construction support apparatus. In the following description, FIGS. 1 to 15 will be referred to as appropriate. Also, in the example embodiment, an inferential knowledge construction support method is implemented by operating the inferential knowledge construction support apparatus. Therefore, description of the inferential knowledge construction support method in the example embodiment will be replaced by the following description of the operations of the inferential knowledge construction support apparatus.

As shown in FIG. 16, initially, the acquisition unit 51 acquires descriptive information 60 corresponding to a natural sentence (sentence/text of natural language sentence) selected by the operator (step A1). Specifically, in step A1, the acquisition unit 51 acquires descriptive information 60 such as text acquired from a URL related to target inferential knowledge or text acquired from an HTML file.

Then, the literal generation unit 2 extracts elements corresponding to the predicate symbol and arguments from the descriptive information corresponding to the selected natural sentence, and generates literal information indicating a literal, based on the extracted elements (step A2). Specifically, in step A2, the literal generation unit 2 generates literal information, using the predicate-argument structure analysis unit 41, the literal conversion unit 42, the normalization unit 43, the predicate list storage unit 46 and the synonym dictionary storage unit 47.

Then, the rule generation unit 3 specifies a causal/implicational relation from the descriptive information corresponding to the selected natural sentence, and generates a rule candidate by allocating the literal information corresponding to the specified sentence to the antecedent and the consequent (step A3). Specifically, in step A3, first, the rule generation unit 3 transmits the descriptive information 60 to the causal/implicational relation analysis unit 44. Then, in step A3, the rule generation unit 3 causes the causal/implicational relation analysis unit 44 to specify a causal/implicational relation, using the descriptive information 60. Then, in step A3, the rule generation unit 3 acquires the specification result from the causal/implicational relation analysis unit 44.

Then, the observation generation unit 52 specifies an observed fact from the descriptive information corresponding to the selected natural sentence, and takes literal information corresponding to the specified sentence as an observation candidate (step A4). Specifically, in step A4, first, the observation generation unit 52 transmits the descriptive information 60 to the observed fact analysis unit 45. Then, in step A4, the observation generation unit 52 causes the observed fact analysis unit 45 to specify an observed fact, using the descriptive information 60. Then, the observation generation unit 52 acquires the specification result from the observed fact analysis unit 45.

Then, when the operator selects to edit a rule or edit an observation, using the user interface displayed on the screen of the display device 50, the editing unit 5, in step A5, acquires the selection result via the editing display information generation unit 58.

Then, the editing unit 5 causes the editing display information generation unit 58 to generate display information corresponding to the selected editing, based on the selection result (step A6). Thereafter, the editing display information generation unit 58 displays a user interface to be used in the selected editing on the screen of the display device 50 (step A7).

Specifically, in step A6, in the case where editing a rule is selected, the editing unit 5 causes the editing display information generation unit 58 to generate display information corresponding to a user interface that is used for editing a rule. Thereafter, in step A7, the editing display information generation unit 58 displays a rule editing user interface 70 such as shown in FIG. 7, for example, on the screen of the display device 50.

Also, in step A6, in the case where editing an observation is selected, the editing unit 5 causes the editing display information generation unit 58 to generate display information corresponding to a user interface that is used for editing an observation. Thereafter, in step A7, the editing display information generation unit 58 displays an observation editing user interface 80 such as shown in FIG. 8, for example, on the screen of the display device 50.

Then, the editing unit 5 edits the rule or observation using the user interface and generates rule information or observation information (step A8). Editing of rule information includes (1) editing for adding a literal to a rule, (2) editing for deleting a literal from a rule, and (3) editing the logical structure of a rule, for example. Also, editing of observation information includes (4) editing for adding a literal to an observation and (5) editing for deleting a literal from an observation, for example.

Then, the editing unit 5 acquires the edited rule information or observation information as the editing result (step A9). Then, the conversion unit 53 converts the edited rule information or observation information to a format for an automatic inference engine (step A10), and stores the resultant information in the inferential knowledge storage unit 49 (step A11).

Specifically, in step A9, first, the conversion unit 53 acquires the rule information or observation information generated by the editing unit 5. Then, in step A10, the conversion unit 53 converts the acquired rule information or observation information to an automatic inference engine format. Thereafter, in step A11, the conversion unit 53 stores the information converted to an automatic inference engine format in the inferential knowledge storage unit 49.

[Effects of Example Embodiment]

According to the example embodiment as described above, by using user interfaces, the operator is able to correct a rule or observation displayed in the rule display area or observation display area with reference to literals displayed in the literal display area, even in the case where a rule (rule candidate) or observation (observation candidate) containing an erroneous literal is generated. Thus, it is possible to improve the work efficiency and accuracy with which inferential knowledge is constructed.

Also, by using user interfaces of the example embodiment, the operator who corrects rule information or observation information is easily able to correct the rule information or observation information, even when he or she is not as knowledgeable as operators in the past.

Also, conventionally, in the case where a rule or an observation contained a deficient literal, the operator added a literal corresponding to the natural sentence with reference to the natural sentence. However, in the example embodiment, the operator is able to easily correct rules while referring to the natural sentence corresponding to literals displayed in the literal display area or the observation display area.

Furthermore, due to the improved work efficiency of the operator, the work cost required to correct erroneous literals can be reduced. Also, by using user interfaces, the state of editing can be visualized, thus enabling work errors by the operator to be reduced.

[Program]

A program in the example embodiment of the invention need only be a program that causes a computer to execute steps A1 to A11 shown in FIG. 16. The inferential knowledge construction support apparatus and inferential knowledge construction support method in the example embodiment can be realized by this program being installed on a computer and executed. In this case, a processor of the computer has the acquisition unit 51, the literal generation unit 2, the rule generation unit 3, the display information generation unit 4, the observation generation unit 52 and the conversion unit 53. The display information generation unit 4 functions and performs processing as the natural sentence display area generation unit 54, the literal display area generation unit 55, the rule display area generation unit 56, the observation display area generation unit 57, the editing display information generation unit 58), and the editing unit 5.

Also, the program in the example embodiment may be executed by a computer system constructed from a plurality of computers. In this case, for example, the computers may each function as one of the acquisition unit 51, the literal generation unit 2, the rule generation unit 3, the display information generation unit 4 (having the observation generation unit 52 and the conversion unit 53; the display information generation unit 4 has the natural sentence display area generation unit 54, the literal display area generation unit 55, the rule display area generation unit 56, the observation display area generation unit 57, the editing display information generation unit 58), and the editing unit 5.

[Physical Configuration]

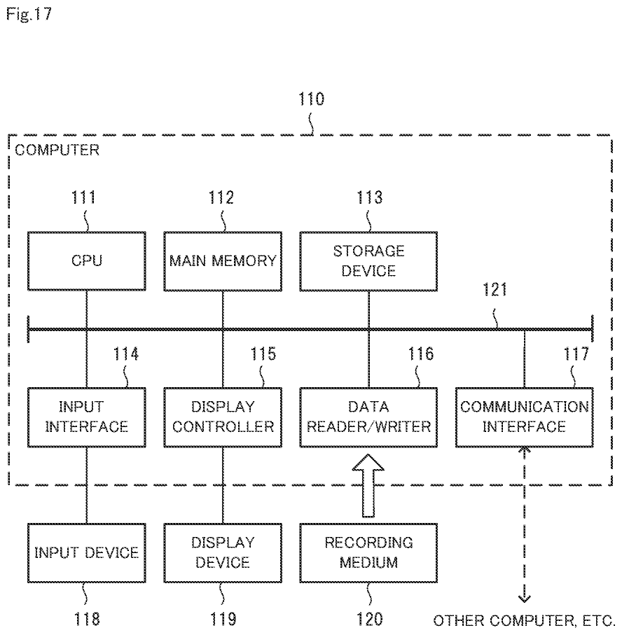

Here, a computer that realizes the inferential knowledge construction support apparatus by executing programs of the example embodiment will be described using FIG. 17. FIG. 17 is a block diagram showing an example of a computer that realizes the inferential knowledge construction support apparatus of the example embodiment of the invention.

As shown in FIG. 17, a computer 110 includes a CPU (Central Processing Unit) 111, a main memory 112, a storage device 113, an input interface 114, a display controller 115, a data reader/writer 116 and a communication interface 117. These constituent elements are connected to each other in a data communicable manner via a bus 121. Note that the computer 110 may also include a GPU (Graphics Processing Unit) or FPGA (Field-Programmable Gate Array) in addition to the CPU 111 or instead of the CPU 111.

The CPU 111 carries out various computational operations by extracting programs (code) of the example embodiment that are stored in the storage device 113 to the main memory 112 and executing these programs in predetermined order. The main memory 112 is typically a volatile storage device such as a DRAM (Dynamic Random Access Memory). Also, programs of the example embodiment are provided in a state of being stored in a computer-readable recording medium 120. Note that programs of the example embodiment may also be distributed over the Internet connected via the communication interface 117.

Also, specific examples of the storage device 113 include a semiconductor storage device such as a flash memory, in addition to a hard disk drive. The input interface 114 mediates data transmission between the CPU 111 and an input device 118 such as a keyboard and a mouse. The display controller 115 is connected to a display device 119 and controls display on the display device 119.

The data reader/writer 116 mediates data transmission between the CPU 111 and the recording medium 120, and executes readout of programs from the recording medium 120 and writing of processing results of the computer 110 to the recording medium 120. The communication interface 117 mediates data transmission between the CPU 111 and other computers.

Also, specific examples of the recording medium 120 include a general-purpose semiconductor storage device such as a CF (Compact Flash (registered trademark) card or SD (Secure Digital) card, a magnetic recording medium such as a flexible disk, and an optical recording medium such as a CD-ROM (Compact Disk Read Only Memory).

Note that the inferential knowledge construction support apparatus 1 in the example embodiment can also be realized by using hardware corresponding to the respective constituent elements, rather than by a computer on which programs are installed. Furthermore, the inferential knowledge construction support apparatus 1 may be partially realized by programs and the remaining portion thereof may be realized by hardware.

The following supplementary notes will be further disclosed in relation to the above example embodiment. The example embodiment described above can be partially or wholly realized by supplementary notes 1 to 12 described below, but the invention is not limited to the following description.

(Supplementary Note 1)

An inferential knowledge construction support apparatus including:

a literal generation unit that extracts elements corresponding to a predicate symbol and an argument from descriptive information indicating a sentence, and generates literal information based on the extracted elements;

a rule generation unit that estimates a causal/implicational relation between literals, using plural pieces of the literal information, and generates rule information by allocating literal information estimated to be in the causal/implicational relation to an antecedent and a consequent;

a display information generation unit that generates display information to be used for causing a display device to output a rule editing user interface for displaying, in a juxtaposed manner, a literal display area for displaying the literal information and descriptive information corresponding to the literal information and a rule display area for displaying the rule information and descriptive information corresponding to the rule information; and

an editing unit that enables an operator to edit the rule information, using the rule editing user interface.

(Supplementary Note 2)

The inferential knowledge construction support apparatus according to supplementary note 1, further including:

an observation generation unit that estimates the literal information corresponding to an observed fact, using plural pieces of the literal information, and generates the estimated literal information as observation information corresponding to the observed fact,

whereby the display information generation unit generates display information to be used for causing the display device to output an observation editing user interface for displaying, in a juxtaposed manner, the literal display area and a rule display area for displaying the observation information and descriptive information corresponding to the observation information, and

the editing unit enables the operator to edit the observation information, using the observation editing user interface.

(Supplementary Note 3)

The inferential knowledge construction support apparatus according to supplementary note 2,

whereby the editing unit, upon a predicate being input to a predicate input area of the rule editing user interface or the observation editing user interface, refers to predicate list information using the input predicate, and searches for information indicating a predicate symbol and a grammatical case corresponding to the predicate, and

the display information generation unit generates display information to be used for displaying, in the predicate input area, information indicating the predicate symbol and grammatical case retrieved in the search.

(Supplementary Note 4)

The inferential knowledge construction support apparatus according to supplementary note 3,

whereby the editing unit, upon an argument being input to an argument input area of the rule editing user interface or the observation editing user interface, refers to synonym dictionary information using the input argument, and normalizes the input argument, and

the display information generation unit generates display information to be used for displaying the normalized argument in the argument input area.

(Supplementary Note 5)

An inferential knowledge construction support method including:

(a) extracting elements corresponding to a predicate symbol and an argument from descriptive information indicating a sentence, and generating literal information based on the extracted elements;

(b) estimating a causal/implicational relation between literals, using plural pieces of the literal information, and generating rule information by allocating literal information estimated to be in the causal/implicational relation to an antecedent and a consequent;

(c) generating display information to be used for causing a display device to output a rule editing user interface for displaying, in a juxtaposed manner, a literal display area for displaying the literal information and descriptive information corresponding to the literal information and a rule display area for displaying the rule information and descriptive information corresponding to the rule information; and

(d) enabling an operator to edit the rule information, using the rule editing user interface.

(Supplementary Note 6)

The inferential knowledge construction support method according to supplementary note 5, further including:

(e) estimating the literal information corresponding to an observed fact, using plural pieces of the literal information, and generating the estimated literal information as observation information corresponding to the observed fact;

(f) generating display information to be used for causing the display device to output an observation editing user interface for displaying, in a juxtaposed manner, the literal display area and a rule display area for displaying the observation information and descriptive information corresponding to the observation information; and

(g) enabling the operator to edit the observation information, using the observation editing user interface.

(Supplementary Note 7)

The inferential knowledge construction support method according to supplementary note 6, further including:

(h) upon a predicate being input to a predicate input area of the rule editing user interface or the observation editing user interface, referring to predicate list information using the input predicate, and searching for information indicating a predicate symbol and a grammatical case corresponding to the predicate; and

(i) generating display information to be used for displaying, in the predicate input area, information indicating the predicate symbol and grammatical case retrieved in the search.

(Supplementary Note 8)

The inferential knowledge construction support method according to supplementary note 7, further including:

(j) upon an argument being input to an argument input area of the rule editing user interface or the observation editing user interface, referring to synonym dictionary information using the input argument, and normalizing the input argument; and

(k) generating display information to be used for displaying the normalized argument in the argument input area.

(Supplementary Note 9)

A computer-readable recording medium that includes a program recorded thereon, the program including instructions that cause a computer to carry out:

(a) a step of extracting elements corresponding to a predicate symbol and an argument from descriptive information indicating a sentence, and generating literal information based on the extracted elements;

(b) a step of estimating a causal/implicational relation between literals, using plural pieces of the literal information, and generating rule information by allocating literal information estimated to be in the causal/implicational relation to an antecedent and a consequent;

(c) a step of generating display information to be used for causing a display device to output a rule editing user interface for displaying, in a juxtaposed manner, a literal display area for displaying the literal information and descriptive information corresponding to the literal information and a rule display area for displaying the rule information and descriptive information corresponding to the rule information; and

(d) a step of enabling an operator to edit the rule information, using the rule editing user interface.

(Supplementary Note 10)

The computer-readable recording medium according to supplementary note 9, the program further including instructions that cause the computer to carry out:

(e) a step of estimating the literal information corresponding to an observed fact, using plural pieces of the literal information, and generating the estimated literal information as observation information corresponding to the observed fact;

(f) a step of generating display information to be used for causing the display device to output an observation editing user interface for displaying, in a juxtaposed manner, the literal display area and a rule display area for displaying the observation information and descriptive information corresponding to the observation information; and

(g) a step of enabling the operator to edit the observation information, using the observation editing user interface.

(Supplementary Note 11)

The computer-readable recording medium according to supplementary note 10, the program further including instructions that cause the computer to carry out:

(h) upon a predicate being input to a predicate input area of the rule editing user interface or the observation editing user interface, referring to predicate list information using the input predicate, and searching for information indicating a predicate symbol and a grammatical case corresponding to the predicate; and

(i) generating display information to be used for displaying, in the predicate input area, information indicating the predicate symbol and grammatical case retrieved in the search.

(Supplementary Note 12)

The computer-readable recording medium according to supplementary note 11, the program further including instructions that cause the computer to carry out:

(j) upon an argument being input to an argument input area of the rule editing user interface or the observation editing user interface, referring to synonym dictionary information using the input argument, and normalizing the input argument; and

(k) generating display information to be used for displaying the normalized argument in the argument input area.

Although the instant invention has been described above with reference to an example embodiment, the invention is not limited to the foregoing example embodiment. Various modifications that will be appreciated by those skilled in the art can be made to the configurations and details of the instant invention within the scope of the invention.

### INDUSTRIAL APPLICABILITY

According to the invention as described above, support can be provided to an operator in order to efficiently construct inferential knowledge. The invention is useful in fields in which construction of inferential knowledge (rules and observations) is required.

### LIST OF REFERENCE SIGNS

1 Inferential knowledge construction support apparatus
2 Literal generation unit
3 Rule generation unit
4 Display information generation unit
5 Editing unit
20, 70 Rule editing user interface
21, 72, 82 Literal display area
22, 73 Rule display area
23 Literal for natural sentence 1
24 Literals for natural sentence 2
25, 74 Antecedent display area
26, 75 Consequent display Area
40 System
41 Predicate-argument structure analysis unit
42 Literal conversion unit
43 Normalization unit
44 Cause and implicational relation analysis unit
45 Observed fact analysis unit
46 Predicate list storage unit
47 Synonym dictionary storage unit
48 Factual expression dictionary storage unit
49 Inferential knowledge storage unit
50 Display device
51 Acquisition unit
52 Observation generation unit
53 Conversion unit
54 Natural sentence display area generation unit
55 Literal display area generation unit
56 Rule display area generation unit
57 Observation display area generation unit
58 Editing display information generation unit
60 Descriptive information
71, 81 Natural sentence display areas
76, 77, 78, 79, 84, 85, 86, 87 Button
80 Observation editing user interface
83 Observation display area
100 Predicate input area
104 Argument input area
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An inferential knowledge construction support apparatus comprising:
a memory storing instructions; and
one or more processors configured to execute the instructions to:
extract elements corresponding to a predicate symbol and an argument from descriptive information indicating a sentence, and generating literal information based on the extracted elements;
estimate a causal or implicational relation between literals, using plural pieces of the literal information, and generating rule information by allocating literal information estimated to be in the causal or implicational relation to an antecedent and a consequent;
generate display information to be used for causing a display device to output a rule editing user interface for displaying, in a juxtaposed manner, a literal display area for displaying the literal information and descriptive information corresponding to the literal information and a rule display area for displaying the rule information and descriptive information corresponding to the rule information; and
enable an operator to edit the rule information, using the rule editing user interface.

2. The inferential knowledge construction support apparatus according to claim 1, further comprising:
estimate the literal information corresponding to an observed fact, using plural pieces of the literal information, and generating the estimated literal information as observation information corresponding to the observed fact,
wherein generate display information to be used for causing the display device to output an observation editing user interface for displaying, in a juxtaposed manner, the literal display area and a observation display area for displaying the observation information and descriptive information corresponding to the observation information, and
enable the operator to edit the observation information, using the observation editing user interface.

3. The inferential knowledge construction support apparatus according to claim 2,
wherein, upon a predicate being input to a predicate input area of the rule editing user interface or the observation editing user interface, refer to predicate list information using the input predicate, and search for information indicating a predicate symbol and a grammatical case corresponding to the predicate, and
generate display information to be used for displaying, in the predicate input area, information indicating the predicate symbol and grammatical case retrieved in the search.

4. The inferential knowledge construction support apparatus according to claim 3,
wherein, upon an argument being input to an argument input area of the rule editing user interface or the observation editing user interface, refer to synonym dictionary information using the input argument, and normalizes the input argument, and
generate display information to be used for displaying the normalized argument in the argument input area.

5. An inferential knowledge construction support method comprising:
extracting elements corresponding to a predicate symbol and an argument from descriptive information indicating a natural sentence, and generating literal information based on the extracted elements;
estimating a causal/implicational relation between literals, using plural pieces of the literal information, and generating rule information by allocating literal information estimated to be in the causal/implicational relation to an antecedent and a consequent;
generating display information to be used for causing a display device to output a rule editing user interface for displaying, in a juxtaposed manner, a literal display area for displaying the literal information and descriptive information corresponding to the literal information and a rule display area for displaying the rule information and descriptive information corresponding to the rule information; and
enabling an operator to edit the rule information, using the rule editing user interface.

6. The inferential knowledge construction support method according to claim 5, further comprising:
estimating the literal information corresponding to an observed fact, using plural pieces of the literal information, and generating the estimated literal information as observation information corresponding to the observed fact;
generating display information to be used for causing the display device to output an observation editing user interface for displaying, in a juxtaposed manner, the literal display area and a observation display area for displaying the observation information and descriptive information corresponding to the observation information; and
enabling the operator to edit the observation information, using the observation editing user interface.

7. The inferential knowledge construction support method according to claim 6, further comprising:
upon a predicate being input to a predicate input area of the rule editing user interface or the observation editing user interface, referring to predicate list information using the input predicate, and searching for information indicating a predicate symbol and a grammatical case corresponding to the predicate; and
generating display information to be used for displaying, in the predicate input area, information indicating the predicate symbol and grammatical case retrieved in the search.

8. The inferential knowledge construction support method according to claim 7, further comprising:
upon an argument being input to an argument input area of the rule editing user interface or the observation editing user interface, referring to synonym dictionary information using the input argument, and normalizing the input argument; and
generating display information to be used for displaying the normalized argument in the argument input area.

9. A non-transitory computer-readable recording medium that includes a program recorded thereon, the program including instructions that cause a computer to carry out:
extracting elements corresponding to a predicate symbol and an argument from descriptive information indicating a natural sentence, and generating literal information based on the extracted elements;
estimating a causal/implicational relation between literals, using plural pieces of the literal information, and generating rule information by allocating literal information estimated to be in the causal/implicational relation to an antecedent and a consequent;
generating display information to be used for causing a display device to output a rule editing user interface for displaying, in a juxtaposed manner, a literal display area for displaying the literal information and descriptive information corresponding to the literal information and a rule display area for displaying the rule information and descriptive information corresponding to the rule information; and
enabling an operator to edit the rule information, using the rule editing user interface.

10. The non-transitory computer-readable recording medium according to claim 9, the program further including instructions that cause the computer to carry out:
estimating the literal information corresponding to an observed fact, using plural pieces of the literal information, and generating the estimated literal information as observation information corresponding to the observed fact;
generating display information to be used for causing the display device to output an observation editing user interface for displaying, in a juxtaposed manner, the literal display area and a observation display area for displaying the observation information and descriptive information corresponding to the observation information; and
enabling the operator to edit the observation information, using the observation editing user interface.

11. The non-transitory computer-readable recording medium according to claim 10, the program further including instructions that cause the computer to carry out:
upon a predicate being input to a predicate input area of the rule editing user interface or the observation editing user interface, referring to predicate list information using the input predicate, and searching for information indicating a predicate symbol and a grammatical case corresponding to the predicate; and
generating display information to be used for displaying, in the predicate input area, information indicating the predicate symbol and grammatical case retrieved in the search.

12. The non-transitory computer-readable recording medium according to claim 11, the program further including instructions that cause the computer to carry out:
upon an argument being input to an argument input area of the rule editing user interface or the observation editing user interface, referring to synonym dictionary information using the input argument, and normalizing the input argument; and
generating display information to be used for displaying the normalized argument in the argument input area.
